(19) United States
(12) Patent Application Publication
(10) Pub. No.: US 2002/0173950 A1
(43) Pub. Date: Nov. 21, 2002

(54) Circuit for improving the intelligibility of audio signals containing speech

(76) Inventor: Matthias Vierthaler, Freiburg (DE)

Correspondence Address: Samuels, Gauthier & Stevens LLP, Suite 3300, 225 Franklin Street, Boston, MA, 02110, US

(21) Appl. No.: 10/152,159

(22) Filed: May 20, 2002

(30) Foreign Application Priority Data
May 18, 2001 (DE) 101 24 699.4

(51) Int. Cl. G10L 11/06

(52) U.S. Cl. 704/208

(57) ABSTRACT

The speech intelligibility of an audio signal of unchanged volume is improved by raising the total audio signal by a constant factor and lowering the amplitude of this raised signal by a high-pass filter. The corner frequency f_{c} of the high-pass filter is adjusted such that the output amplitude of the audio signal at the end of the processing segment is equal or proportional to the input amplitude of the audio signal.

### BACKGROUND OF THE INVENTION

The present invention relates to the field of signal processing, and in particular to signal processing of audio signals containing speech.

There are a variety of approaches to improving the speech intelligibility of audio signals. One approach is to improve the noisy audio signal. Another approach is to improve the signals that have been degraded by reverberation and echoes, etc. Yet another approach is that a good audio signal may be modified to make it more intelligible for the hearing-impaired—a method used, for example, in hearing aids. It is also possible to modify a good audio signal so it is more intelligible in the presence of high background noise.

U.S. Pat. No. 5,459,813 discloses that “unvoiced sounds” (e.g., consonants) are masked by much stronger “voiced sounds” (e.g., vowels). Since unvoiced sounds are critical for the intelligibility of speech, this patent disclosing enhancing these sounds, for example, by clipping or amplitude compression.

The publication entitled “Effects of Amplitude Distortion upon Intelligibility of Speech” by J. C. Liqulider in the Journal of the Acoustical Society of America, October 1946 discloses “peak clipping”. This peak clipping without ambient noise has little effect on the intelligibility of speech. Peak clipping at −20 dB still yields approximately 96% intelligibility. “Center clipping” is considerably worse since the consonants are removed, which are especially critical to intelligibility. Peak clipping at −24 dB requires amplification of only approximately 14 dB to obtain the same intelligibility. In the publication Speech Monographs, March 1960, the article by Elwood Kretsinger et al. entitled “The Use of Fast Limiting to Improve the Intelligibility of Speech in Noise” discloses that consonants are approximately 12 dB weaker than vowels. Thus, by amplifying the consonants relative to the vowels, the intelligibility of speech in the audio signal is increased. Replacing the clipper with a fast peak limiter (22 msec.) enables intelligibility to be increased still further. At −10 dB limiting, intelligibility is increased from 56% to 84%.

From the article by Ian Thomas et al., entitled “The Intelligibility of Filtered-Clipped Speech in Noise” in the Journal of the Audio Engineering Society, June 1970, it is known that the fundamental wave of an audio signal that contains speech contributes very little to speech intelligibility, while the first resonance frequency is extremely important. For this reason, the signal should be high-pass-filtered before clipping.

From the article by Ian Thomas et al., entitled “Intelligibility Enhancement through Spectral Weighting,” in the Proceedings of the 1972 IEEE Conference on Speech Communication and Processing, it is known that, while clipping does improve the intelligibility of speech, it also degrades signal quality. Therefore, this publication proposes shifting the signal energy into the significant frequency ranges.

U.S. Pat. No. 5,479,560 discloses an approach in which the audio signals are broken up into multiple frequency bands, and the high-energy frequency bands are amplified relatively strongly while the others are lowered. This technique is based on the fact that speech is composed of a sequence of phonemes. Phonemes consist of a plurality of frequencies that undergo significant amplification at the resonance frequencies of the mouth and throat cavity. A frequency band with this type of spectral peak is called a formant. Formants are especially important for the recognition of phonemes and thus speech. Therefore, one approach to improving speech intelligibility involves amplifying the peaks (formants) of the frequency spectrum of an audio signal while attenuating the intermediate valleys. For an adult male, the fundamental frequency of speech is in the range of approximately 60-240 Hz. The first four formants are at 500 Hz, 1,500 Hz, 2,500 Hz, and 3,500 Hz as disclosed in U.S. Pat. No. 5,459,813.

U.S. Pat. No. 4,454,609 discloses having the cononants undergo amplification.

U.S. Pat. No. 5,553,151 discloses “forward masking”, wherein weak consonants are temporarily masked by the preceding strong vowels. This patent discloses a relatively fast compressor with an “attack time” of approximately 10 msec., and a “release time” of approximately 75 to 150 msec.

A problem inherent in the known systems for improving the intelligibility of speech in audio signals is their relatively high complexity. That is, there is a high level of complexity in both the software requirement to calculate the individual algorithms and in the hardware requirement. On the other hand, in the simpler systems the audio signal is modified to such an extent that the speech no longer sounds natural. In addition, certain disturbances may be imparted on the speech signal in the simpler systems that may even work against improved intelligibility.

Therefore, there is a need for an apparatus and method of reduced complexity for improving the speech quality of audio signals. In addition, there is a need for an apparatus and method of improving the speech intelligibility of a relatively good audio signal with the volume unmodified. That is, a system wherein the intelligibility remains the same at low volume or that intelligibility is improved in the presence of ambient noise.

### SUMMARY OF THE INVENTION

An audio input signal is amplified by a predetermined factor and filtered in a high-pass filter, wherein the corner frequency of the high-pass filter is adjusted so that the amplitude of a processed audio output signal is equal to or proportional to the amplitude of the audio input signal.

A circuit of the present invention enables the fundamental wave of a speech signal, which contributes little to intelligibility but possesses the highest energy, to be attenuated and the remaining signal spectrum of the audio signal to be correspondingly raised. In addition, the amplitude of the vowels (high amplitude, low frequency) can be lowered in the consonant-to-vowel transition range (low amplitude, high frequency) to reduce the so-called “backward masking.” To accomplish this, the entire signal is raised by a factor g. This factor controls the strength of the signal improvement effect, usable values for the factor g ranging between approximately 1.5 and 4. The circuit/system of the present invention raises the higher-frequency components while lowering the low-frequency fundamental wave to the same degree so that the amplitude (or energy) of the audio signal remains unchanged. With regard to signal components of small amplitude, that is, consonants, the circuit lowers the corner frequency of the variable high-pass filter. For this reason, an offset may be added in the control element to the input signal, the offset being either fixed or proportional to the peak amplitude of the input-side audio signal.

In an alternative embodiment, the higher-frequency signal components in the audio signal are lowered. A low-pass filter before the variable high-pass filter allows disturbances in the signal to be suppressed.

In yet another alternative embodiment, the corner frequency f_{c} of the variable high-pass filter is limited on the low side since the lowest frequency of speech is approximately 200 Hz. A lower corner frequency in the range of approximately 100 Hz to 120 Hz has proven to be useful.

These and other objects, features and advantages of the present invention will become more apparent in light of the following detailed description of preferred embodiments thereof, as illustrated in the accompanying drawings.

### BRIEF DESCRIPTION OF THE DRAWING

FIG. 1 is a block diagram illustration of an audio signal processing system;

FIG. 2 is a block diagram illustration of an alternative embodiment audio signal processing system;

FIG. 3 is a block diagram illustration of another alternative embodiment audio signal processing system;

FIG. 4 is a block diagram illustration of an alternative embodiment comparison circuit; and

FIG. 5 is a block diagram illustration of another alternative embodiment comparison circuit.

### DETAILED DESCRIPTION OF THE INVENTION

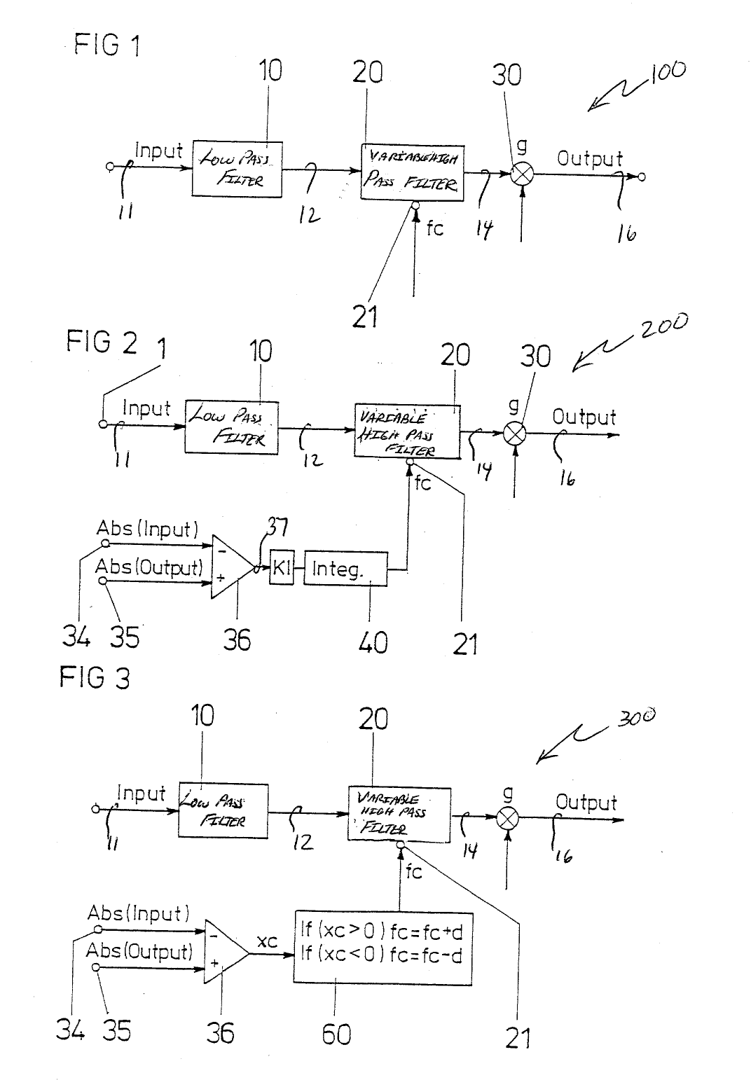

FIG. 1 is a block diagram illustration of an audio signal processing system 100. The system includes a low pass filter (LPF) 10 that receives an audio signal on a line 11. The LPF 10 provides a low pass filtered signal on a line 12 to a variable high pass filter 20 having an adjustable corner frequency f_{c}. The variable high pass filter 20 receives a frequency control signal on a line 21 that sets the corner frequency f_{c}. The filter 20 provides a high pass filtered signal on a line 14 to an amplifier 30 having a gain g, which provides a processed audio signal on a line 16. The gain value g is adjustable and is preferably in the range of between approximately 1.5 and 4. Once an amplification factor is set, it is preferably not changed.

The value of the corner frequency f_{c} of the variable high-pass filter 20 is controlled to improve the intelligibility of speech in the audio signal. If the amplitude (or energy) of the input signal on the line 11 is greater than the amplitude (or energy) of the process audio signal on the line 16, then the value of the corner frequency f_{c} is decreased. If the amplitude (or energy) of the input signal on the line 11 is less than the amplitude (or energy) of the process audio signal on the line 16, the value of the corner frequency f_{c} is increased. When the amplitudes of the input signal on the line 11 and the processed audio signal on the line 16 are the same or proportional by a predetermined factor, there is no further modification of the corner frequency value f_{c}.

FIG. 2 is a block diagram illustration of an alternative embodiment audio signal processing system 200. This embodiment is essentially the same as the embodiment illustrated in FIG. 1, with the principal exception that a comparator 36 receives the absolute values of the signal on the line 12 and the processed audio signal on the line 16, and provides a difference signal on a line 37. The difference signal on the line 37 is multiplied by a scaling factor Ki, and the resultant product is input to an integrator 40, which provides the corner frequency control signal on the line 21.

FIG. 3 is a block diagram illustration of another alternative embodiment audio signal processing system 300. The system illustrated in FIG. 3 is essentially the same as the system illustrated in FIG. 2, with the principal exception that the scaled integrator in FIG. 2 has been replaced with a digital circuit 60. The digital circuit 60 receives the difference signal on the line 37, and provides the corner frequency control signal on the line 21. The digital circuit increases the value of the corner frequency f_{c} by a value d if the difference signal on the line 37 is greater than zero. The digital circuit 60 decreases the corner frequency f_{c} by a value d if the difference signal on the line 37 is less than zero.

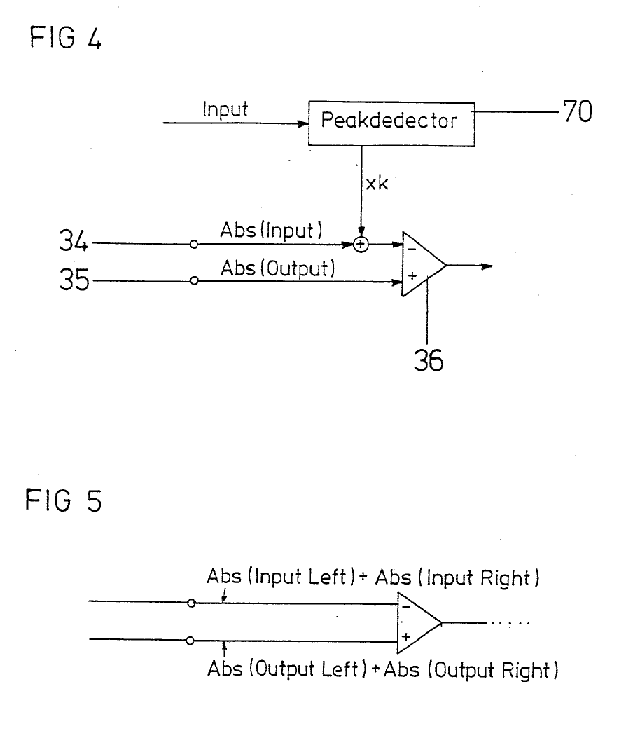

FIG. 4 is a block diagram illustration of an alternative embodiment comparison circuit 400. In this embodiment, the input signal on the line 11 is input to a peak detector 70, which provides a peak detected signal value on a line 72, which may be multiplied by a factor K to provide an offset signal value on a line 74. The offset signal value is input to a summer 76 that also receives the signal on the line 34. In yet another embodiment, the offset may simply be a constant value.

The audio signal processing circuit of the present invention allows the fundamental wave of the audio signal to be lowered, and the rest of the signal component to be raised. This function is achieved by the variable high-pass filter 20.

In the event a consonant follows a vowel in the speech signal, the circuit functions as follows: a vowel has a low frequency and a high amplitude. Conversely, a consonant has a high frequency and a low amplitude. The amplification factor value g is preferably adjusted to achieve an amplification of 6 dB. Based on the low-frequency vowel, the corner frequency of the variable high-pass filter 20 is adjusted to this low frequency. As a result, the fundamental wave is lowered to the point that the output amplitude is equal to the input amplitude of the audio signal, even though the selected amplification is 6 dB. If a consonant (higher frequency) now follows the vowel, this consonant is raised 6 dB since the corner frequency of the high-pass filter 20 is still set for the low frequency of the vowel. The consonant is masked to a lesser degree by the vowel. Only after a few milliseconds does the value of the corner frequency f_{c} increase, thereby lowering the consonant as well so that the amplitude of the input signal is equal to the amplitude of the output signal of the processing segment.

During a transition from consonant to vowel, the circuit illustrated in FIG. 1 functions as follows. The high-pass filter 20 is adjusted to the frequency of the consonant, and as a result the amplitude of the input signal corresponds to the amplitude of the processed audio signal. If a vowel (low-frequency) now follows, the vowel is attenuated during the temporal transition due to the relatively high corner frequency f_{c} of the high-pass filter 20, and the consonant is consequently not masked. After a few milliseconds the value of the corner frequency f_{c} is adjusted based on the acting time of the loop so that the amplitude of the input signal corresponds to the amplitude of the output signal.

In a stereo signal, it is possible either to have each channel use its own control as described above, or the channels may use a common control. For example, FIG. 5 is a block diagram illustration of another alternative embodiment comparison circuit 500. In this case, for example the sum of the signal values Abs(Input_Left) and Abs(Input_Right) is applied to the inverting input of the comparator, and the sum of the signal values Abs(Output_Left) and Abs(Output_Right) is applied to the non-inverting input to the comparator. The audio path (i.e., high-pass, low-pass, gain) is computed separately for left and right, but the high-pass filters have the same corner frequency f_{c}.

Although the present invention has been shown and described with respect to several preferred embodiments thereof, various changes, omissions and additions to the form and detail thereof, may be made therein, without departing from the spirit and scope of the invention.

What is claimed is:

1. Circuit for improving the intelligibility of audio signals containing speech in which frequency and/or amplitude components of the audio signal are modified according to predetermined parameters,
wherein the audio signal is amplified by a predetermined factor g in a processing segment and passed through a high-pass filter (20), a corner frequency f_{c} of the high-pass filter (20) being adjustable such that the amplitude of the audio signal (2) following the processing segment is equal or proportional to the amplitude of the audio signal before the processing segment.

2. Circuit according to claim 1, wherein the factor is selected so that g is greater than or equal to one.

3. Circuit according to claim 1, wherein the factor g is selected to be approximately in the range between 1.5 and 4.

4. Circuit according to claim 1, wherein the corner frequency f_{c} is lowered whenever the amplitude of the input signal is greater than the amplitude of the output signal at the output of the processing segment, and is raised whenever the reverse is true.

5. Circuit according to claim 4, wherein the change in the corner frequency f_{c} proceeds incrementally, preferably in Hz steps.

6. Circuit according to claim 5, wherein the corner frequency f_{c} is variable in the range between approximately 100 Hz and 1 kHz.

7. Circuit according to claim 6, wherein the lower corner frequency f_{c} lies approximately in the range between 100 Hz and 120 Hz.

8. Circuit according to claim 7, wherein a low-pass filter (10) is connected before the variable high-pass filter (20).

9. Circuit according to claim 8, wherein the low-pass filter (10) has a corner frequency of approximately 6 kHz.

10. Circuit according to claim 9, wherein a comparator (36) is connected to one control input (21) of the variable high-pass filter (20) to modify the corner frequency (f_{c}), the input signal of the processing segment being applied to one input (34) of the comparator and the output signal of the processing segment being applied to the other input (35) of the comparator.

11. Circuit according to claim 10, wherein an integrator (40) is connected between the control input (21) of the variable high-pass filter (20) and the output of the comparator (36).

12. Circuit according to claim 10, wherein a digital circuit (60) to increment the corner frequency f_{c} in steps (d) is provided between the control input (21) of the variable high-pass filter (20) and the output of the comparator (36).

13. Circuit according to claim 12, wherein an offset is added to the input signal at one input (34) of the comparator (36).

14. Circuit according to claim 13, wherein the audio signal is a stereo signal, and that the sum of the input signals for the left and right channel is fed to a first input (34) of the comparator (36), and that the sum of the output signal for the left and right channel is fed to the second input (35) of the comparator (36).
